(19) United States
(12) Patent Application Publication
(10) Pub. No.: US 2024/0421623 A1
(43) Pub. Date: Dec. 19, 2024

(54) SYSTEM AND METHOD FOR MULTI-OBJECTIVE CHARGING CONTROL OPTIMIZATION

(71) Applicant: GM Global Technology Operations LLC, Detroit, MI (US)

(72) Inventors: Xueyu Zhang, Northville, MI (US); Yongjie Zhu, Troy, MI (US); Chunhao J. Lee, Troy, MI (US); Yue-Yun Wang, Troy, MI (US); Madhumita Ramesh Babu, Northville, MI (US); Chen-fang Chang, Bloomfield Hills, MI (US); Jun-mo Kang, Ann Arbor, MI (US)

(21) Appl. No.: 18/336,095

(22) Filed: Jun. 16, 2023

(51) Int. Cl. H02J 7/00; B60L 53/30; B60L 53/62

(52) U.S. Cl. CPC H02J 7/00712; B60L 53/305; B60L 53/62; H02J 7/0048; H02J 7/005; H02J 7/007192

(57) ABSTRACT

A vehicle includes at least one electric motor configured to convert electric power to rotational motion, a battery system electrically connected to the at least one electric motor, and a controller coupled to the battery system. The controller includes a non-transitory computer readable memory and a processor. The memory stores a charging control software module configured to cause the processor to perform the method of: determining an optimum charging profile based at least partially on an available received charging power, an ambient temperature of the battery system, charging system constraints, and at least one driver preference.

### INTRODUCTION

The subject disclosure relates to charging systems for electric and hybrid electric vehicles, and more specifically to a control logic for coordinating thermal and electric conditions for a charging operation.

Vehicles, including electric and hybrid electric vehicles, feature battery storage for purposes such as powering electric motors, electronics and other vehicle subsystems. Vehicle battery systems may be charged using power sources such as charging stations, other electric vehicle battery systems and/or an electrical grid. In current systems, batteries are charged at their maximum charging limit. This charging decision is made solely based on minimizing charge time without consideration for other factors. However, charging the battery at full charge current at low temperatures is inefficient and can result in inefficiency losses.

Accordingly, it is desirable to provide an adaptive charging strategy that is able to account for multiple objectives.

### SUMMARY

In one exemplary embodiment a vehicle includes at least one electric motor configured to convert electric power to rotational motion, a battery system electrically connected to the at least one electric motor, a controller coupled to the battery system, the controller including a non-transitory computer readable memory and a processor, the memory storing a charging control software module, the charging control software module being configured to cause the processor to perform the method of determining an optimum charging profile based at least partially on an available received charging power, an ambient temperature of the battery system, charging system constraints, and at least one driver preference.

In addition to one or more of the features described herein the at least one driver preference includes a relative ranking of a set of parameters including at least charging time, cost-energy efficiency, monetary cost, and a battery life.

In addition to one or more of the features described herein the charging system constraints include at least one of an expected distance to next available charge and an expected time until departure.

In addition to one or more of the features described herein determining the optimum charging profile comprises minimizing the cost equation: Eₜ₌₀^{N}g(X, u, W), where g(X, u, W)=α*(1−η_{eff})+β+Δt*(SOCₜ≤SOC_{target})+γ*i_{aging}, and where, η_{eff} is a system efficiency, Δt is the time step used by the optimization algorithm, SOC_{target} is the final charging target of state of charge, i_{aging} is an aging rate of a battery, X is a set of state variables include a battery temperature T and a state of charge SOC, may have other possible other state variable, e.g. lithium ion surface density, u is a ratio of battery charge to battery thermal (heat or cool) power, and W is an available power from outsource to the vehicle, maybe through the charger or through wireless.

In addition to one or more of the features described herein the cost equation further includes at least one of a charging time is less than driver needs, state of charge end equals state of charge target, power required by the battery is less than charge limits, power required by thermal systems (heater or cooling) is less than a thermal system power limit, and power required by the battery plus power required by the thermal system is less than a total available power.

In addition to one or more of the features described herein the memory further stores a charging profile selection module configured to cause the controller to output a plurality of charging profiles to a user selection system and is configured to cause the controller to implement a selected one of the plurality of charging profiles.

In addition to one or more of the features described herein the at least one driver preference includes a relative ranking of a set of parameters including at least charging time, cost-energy efficiency, charging monetary cost, and a battery life, and wherein the plurality of charging profiles corresponds to a unique driver preference ranking.

In another exemplary embodiment a method for controlling a vehicle charging operation, the method includes determining, using a controller evaluating an optimization cost function, an optimum charging profile based at least partially on an available received charging power, an ambient temperature of a battery system, charging system constraints, and at least one driver preference, wherein the optimization cost function balances a power requirement of a battery thermal system and a battery charging system.

In addition to one or more of the features described herein evaluating an optimization cost function comprises minimizing the cost equation: Eₜ₌₀^{N}g(X, u, W), where g(X, u, W)=α*(1−η_{eff})+β*Δt*(SOC)≤SOC_{target})+γ*i_{aging}, and where, η_{eff} is a system efficiency, Δt is the time step used by the optimization algorithm, SOC_{target} is the final charging target of state of charge, i_{aging} is an aging rate of a battery, X is a set of state variables include a battery temperature T and a state of charge SOC, u is a ratio of battery charge to battery thermal power, and W is an available power from outsource to the vehicle maybe through the charger or through wireless

In addition to one or more of the features described herein the cost equation further includes at least one of a charging time is less than driver needs, state of charge end equals state of charge target, power required by the battery is less than a charge power limit, power required by a thermal system (heater or cooler) is less than a thermal system power limit, and power required by the battery plus power required by thermal system is less than a total available power.

In addition to one or more of the features described herein the memory further stores a charging profile selection module configured to cause the controller to output a plurality of charging profiles to a user selection system and is configured to cause the controller to implement a selected one of the plurality of charging profiles.

In addition to one or more of the features described herein the at least one driver preference includes a relative ranking of a set of parameters including at least charging time, cost-energy efficiency, and a battery life, and wherein the plurality of charging profiles corresponds to a unique driver preference ranking.

In addition to one or more of the features described herein the at least one driver preference includes a relative ranking of a set of parameters including at least charging time, cost-energy efficiency, and a battery life.

In addition to one or more of the features described herein the charging system constraints include at least one of an expected distance to next available charge and an expected time until departure.

In yet another exemplary embodiment a charging control module for a vehicle including a plurality of inputs configured to receive at least a temperature sensor output and an available wall power value, a plurality of outputs configured to output at least a thermal power control signal and a charging power control signal, a processor and a memory storing instructions configured to cause the processor to evaluate an optimization cost function and thereby determine an optimum charging profile based at least partially on an available received charging power, an ambient temperature of a battery system, charging system constraints, and at least one driver preference, wherein the optimization cost function balances a power requirement of a battery thermal system and a battery charging system, wherein evaluating an optimization cost function comprises minimizing the cost equation: Eₜ₌₀^{N}g(X, u, W), where g(X, u, W)=α*(1−η_{eff})+β *Δt*(SOCₜ≤SOC_{target})+γ *i_{aging}, and where, η_{eff} is a system efficiency, Δt is the time step used by the optimization algorithm, SOC_{target} is the final charging target of state of charge, i_{aging} is an aging rate of a battery, X is a set of state variables include a battery temperature T and a state of charge SOC, may have other possible other state variable, e.g. lithium ion surface density, u is a ratio of battery charge to battery thermal power, and W is an available power from outsource to the vehicle maybe through the charger or through wireless.

In addition to one or more of the features described herein further includes a battery aging sub-module, the battery aging sub module being configured to determine at least the aging rate of the battery based on a charging rate of the battery and a temperature of the battery.

In addition to one or more of the features described herein further includes at least one user selection system configured to display a plurality of charging profiles, receive a user selection of a single charging profile from the plurality of charging profiles, and implement the charging profile.

In addition to one or more of the features described herein further includes a user selection figure configured to allow a user to input one or more constraints, and wherein evaluating an optimization cost function includes constraining the optimization cost function with the one or more constraints.

In addition to one or more of the features described herein the one or more constraints includes at least one constraint selected from the list of: a charging time is less than driver needs, state of charge end equals state of charge target, power required by the battery is less than charge limits, power required by a thermal system is less than a thermal system power limit, and power required by the battery plus power required by the thermal system is less than a total available power.

In addition to one or more of the features described herein the one or more constraints includes an ordered ranking of priorities.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including an electric powered propulsion system;

FIG. 2 is a control architecture for a cold start charging procedure in the vehicle of FIG. 1;

FIG. 3A is a state of charge projection, with respect to time, generated by the control architecture of FIG. 2;

FIG. 3B is a charging current projection, with respect to time, generated by the control architecture of FIG. 2; and

FIG. 4. is a schematic representation of a battery charging system for the vehicle of FIG. 1.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with an exemplary embodiment a vehicle includes a control logic that permits the vehicle to optimize a charging operation including providing battery heating using wall power when the battery is under low temperatures or cooling using wall power when battery temperature is high. The control logic provides a centralized framework for determining an optimum charging and thermal profile based on multiple competing objectives (e.g., charge speed, charge efficiency, thermal efficiency, etc.) using a cost function. In one specific example, the control architecture can generate multiple distinct profiles representing different prioritization of the objectives and present the distinct charging profiles to a vehicle operator. The vehicle operator selects the charging profile that best matches their objectives, and the vehicle implements the charging profile.

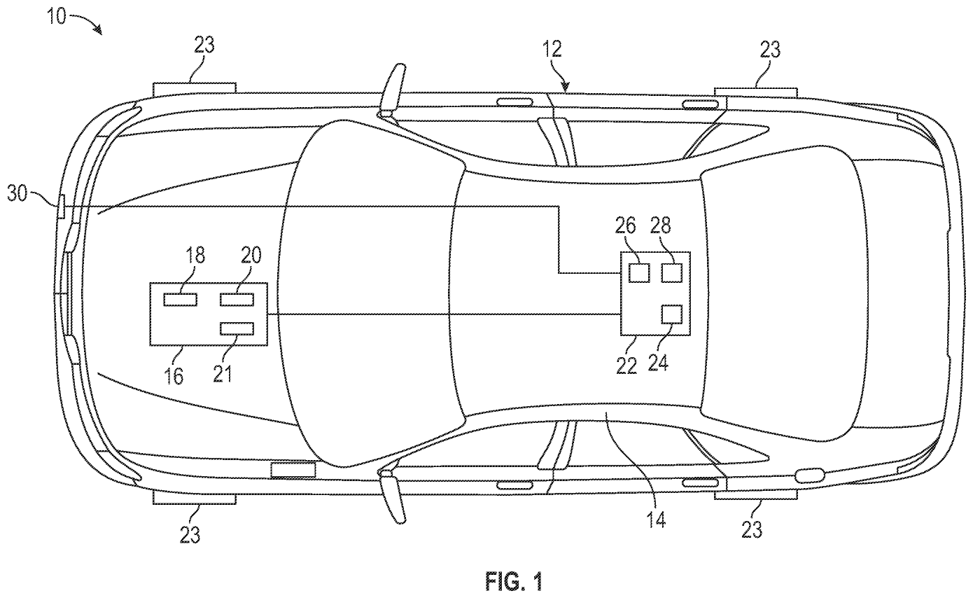

With continued reference to the general system and method described above, FIG. 1 shows an embodiment of a motor vehicle 10 including a battery system controller 24 configured to implement the control architecture. The vehicle 10 includes a vehicle body 12 defining, at least in part, an occupant compartment 14. The vehicle body 12 also supports various vehicle subsystems including a propulsion system 16, a battery system 22, other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. For example, the propulsion system 16 includes a first electric motor 20 and a second electric motor 21. The motors 20 and 21 may be configured to drive wheels 23 on opposing sides of the vehicle 10. Any number of motors positioned at various additional locations about the vehicle 10 may be used to provide mechanical rotation to corresponding systems and subsystems.

The battery system 22 may be electrically connected to the motors 20 and 21 and/or other components, such as vehicle electronics. The battery system 22 may be configured as a rechargeable energy storage system (RESS), and includes multiple cells partitioned into portions. A battery system controller 24 is included within the battery system 22 and controls the charging and discharging functions of the batteries within the battery system 22. In alternative configurations, the battery system controller 24 can be a general vehicle controller remote from the battery system 22 and configured to control multiple systems and/or subsystems. The general vehicle controller can be located at any position within the vehicle 10. In yet further alternatives, the battery system controller 24 can be a distributed control system including multiple coordinating controllers throughout the vehicle 10 encompassing controllers within the battery system 22 and controllers remote from the battery system 22.

A charging port 30 is provisioned at an exterior location on the vehicle 10, and electrically coupled to the battery system 22. The charging port 30 facilitates the provision of wall power to the battery system 22 for a charging operation. As used herein “wall power” refers to any stationary electric power source independent of the vehicle 10 and is not limited strictly to power outlets provisioned in a wall. Wall power can be provided in any number of forms including 120 volt alternating current (120 VAC), 240 volt alternating current (240 VAC) and 480 volt direct current (480 VDC), 800 VDC, or higher. The exemplary voltages are non-limiting in nature, and it is understood that alternate voltages may be also be used. Further, the charging port 30 can be any suitable port for allowing power from exterior to the vehicle 10 to be provided to the battery 22, including both wired power charging and wireless charging, and in some examples charging a first vehicle from a second vehicle.

During operation of an electric vehicle, or a hybrid electric vehicle, the battery system 22 is discharged in order to provide power to the motors 20, 21 as well as to other systems within the vehicle 10. While the vehicle 10 is not moving, electric power can be received through a connection to an external power source, such as through the charging port 30, and the battery system controller 24 controls the receipt of power from the charging port 30 to the battery system 22.

The rate at which the battery can be charged depends on where the vehicle 10 is connected (e.g. a 120 VAC home charging port, a 240 VAC home charging port, or a 480V DC fast charging port) and what current the wall charger can output. In addition, while cold a lithium (Li) battery, or similar type of battery has a slower diffusion rate, and thus cannot charge as fast. Additionally, when the battery temperature is too hot, the battery cannot charge at peak charging speed, since the charging self-heats the battery with the faster the battery charges, the faster the temperature increases. As a result it is desirable to maintain the temperature within a window defined by an upper temperature bound and a lower temperature bound. The wall power can be used to heat or cool the battery during this charging process. However, any power diverted to heating or cooling the battery necessarily reduces the amount and rate of power available for charging. Thus, the controller is faced with an optimization problem.

Existing systems provide separate controllers or control modules for the thermal controls that maintain a battery pack within an ideal charging temperature range, and for the charging controls that control the provision of power from the wall charger to the battery pack. Each of these controllers are rule based, with the control rules being set independent of, and without consideration for, the other system(s) that compete for power during a charging operation. This can introduce inefficiencies resulting in longer charge times, wasted power, etc.

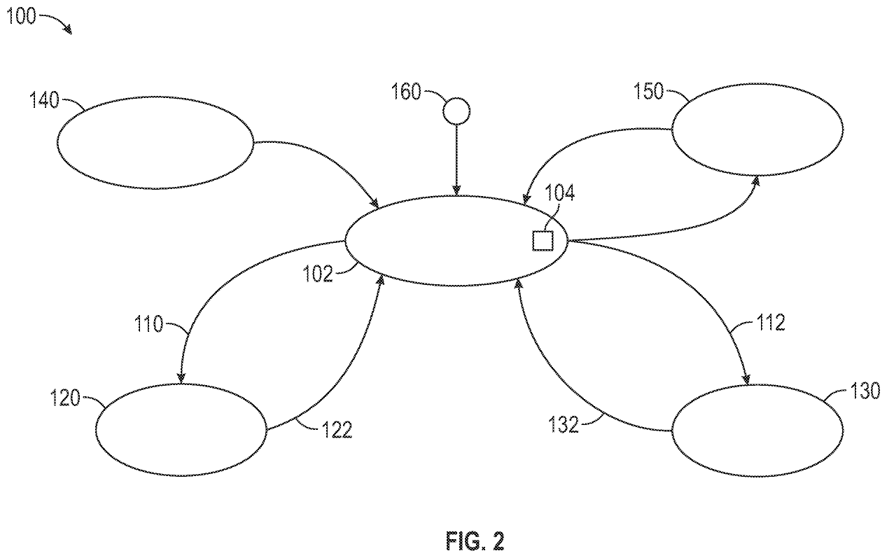

The exemplary embodiments resolve the optimization problem and the conflicting goals of the thermal system 28 and the charging systems by using a control architecture 100, illustrated in FIG. 2, where the battery system controller 24 includes a charging control software module 102. The charging control software module 102 includes a cost function configured to determine a charge strategy based primarily on available wall charging power, ambient and battery temperature, charging system specific constraints, and any additional information provided by the driver. By way of example, the additional information includes a prioritization of at least a charging time, a charging efficiency, and/or a battery life. In order to balance optimum operating conditions, the charging control software module 102 includes an optimization cost function (e.g., EQN 1, described herein) that coordinates thermal conditions of batteries 26 and charging characteristics from the charging port 30 in order to achieve several optimum charge profiles with consideration of both thermal power expenditure and charge power availability, and to allow the vehicle operator to select the optimum charge profile based on his or her preference. The cost function balances competing priorities and constraints and determines an ideal electrical profile (e.g., current, voltages, etc.) and thermal profile (e.g., heater activation, cooler activation, etc.) in order to best achieve several charging profile meeting the predetermined constraints.

The charging control software module 102 centralizes the thermal and charging controls thereby replacing the rule based control of the thermal systems 28 and replacing the rule based power limit based control of the charging system with a cost function optimization. The control system 100 provides operational outputs to a charging port control 120 via charging control signals 110. The charging control signals 110 dictate the power requests from the wall charger and control the characteristics of the received power as required by an optimal controller or control algorithm, including the optimization cost function. The charging port control 120 can be another software module within the battery system controller 24, an independent software module within another controller, or a specific hardware, or partially hardware, based charging port control system.

To facilitate the usage of the optimization cost function, the charging port control 120 provides an output 122 to the charging control software module 102. The output 122 defines the available power characteristics and provides any available sensor information from the charging port 30 to the charging software control module 102.

Similarly, the charging software control module 102 provides operational outputs to a thermal control system 130 via a thermal control signal 112. As with the charging port control 120, the thermal control 130 can be another software module within the battery system controller 24, independent software module within another controller, or a specific hardware or partially hardware controller for the thermal systems 28. A thermal control signal 112 is output to the thermal system 28 and controls the operations of the thermal system 28 according to the optimization cost function included within the charging software control module 102.

The thermal control 130 provides a signal 132 defining a current temperature, expected power usage, and the like of the thermal systems 28 used to maintain the vehicle battery within a desired charging temperature window.

In addition, the battery system controller 24 includes a required charging/heating or cooling time prediction module 140 that uses established models to predict how long a charging and heating or cooling operation will take based on the commanded power usage of each of the charging systems and the thermal systems 28. The required heating or cooling and charging times are provided to the charging control software module 102 via a signal 142, and the estimated times are utilized by the optimization cost function.

In some examples, the charging control software module 102 can be interconnected with a phone app, or receive a direct input from the vehicle operator, and can receive an expected departure time through an input 160. In such cases, the charging control software module 102 can utilize the combination of the expected departure time, and the predicted charging operation time to determine when to start the charging operation, and/or can use the departure time in determining the system constraints.

In one specific example, the optimization cost equation is defined by EQN. 1:

$${\sum }_{t = 0}^{N} g ( X , u , W ) , where$$

$$g ( X , u , W ) = α * ( 1 - {η}_{e f f} ) + β * Δ t * ( S O {C}_{t} \leq S O {C}_{target} ) + γ * {i}_{a g i n g}$$

Within EQN 1., η_{eff} is a system efficiency, Δt is the time step used by the optimization algorithm, SOC_{target} is the final charging target of state of charge, i_{aging} is an aging rate of a battery, X is a set of state variables include a battery temperature T and a state of charge SOC, may have other possible other state variable, e.g. lithium ion surface density, u is a ratio of battery charge to battery thermal (heating or cooling) power, and W is an available power from an outside source to the vehicle such as would be available through the wall charger or through wireless charging.

In alternate examples, alternate cost functions can be utilized to identify the desired optimization. The alternate examples can include multiple optimization cost equations that combine to find multiple optimal charging and thermal profiles for a customer to select between. In other alternate examples, the optimization cost function depends on the type and form of the models used to predict the behaviors of the system.

In one alternate example, the cost equation used can be Equation 2:

$$J = {\sum }_{k = 1}^{N} ( ( 1 - q ( k ) ) + α * max ( T ( k ) - {T}_{max} , 0 ) + β * \vert {p}_{heat} ( k ) \vert )$$

with the constraints of.

$$\{ \begin{matrix}α ≫ 0 , β > 0 \\ q ( k ) \leq 1 \\ 0 \leq {p}_{c h r g} ( k ) \leq {p}_{w all} , \vert {p}_{h e a t} ( k ) \vert \leq {P}_{wall} \\ {p}_{c h r g} ( k ) + \vert {p}_{h e a t} ( k ) \vert \leq {P}_{wall} \\ {i}_{c} ( k ) \leq {i}_{c}^{max} ( q ( k ) , T ( k ) )\end{matrix}$$

Where α is the weighting factor for temperature control and β is the weighting factor for power control which is used for heating, T(k) is the battery temperature at the k^{th} step, Tₘₐₓ is the battery temperature limit, q (k) is the ratio of real-time charges present in a battery to full battery capacity charges at the k^{th} step, p_{chrg}(k) is the power used for charging at the k^{th} step, pₕₑₐₜ(k) is the power used for heating at the k^{th} step, p_{wall} is the available wall power, i_{c}(k) is the charging current at the k^{th} step, i_{c}^{max}(q (k), T (k)) the maximum charging current which depends on the ratio q(k) and the battery temperature T(k) at the k^{th} step.

Common across all of the examples including those explicitly disclosed herein and the alternate examples is the usage of cost equations including multiple objectives and weighting factors corresponding to each objective.

The cost equation can, in some examples, further include optional constraints that limit the potential solutions that can be defined. By way of example, some constraints on the cost function can include a charging time being less than the time before a departure, a state of charge end being equal to a state of charge target, a power required by the battery being less than a charge power limit, a power required by thermal system (a heater or cooler) being less than thermal system power limit, and a power required by the battery plus power required by thermal system is less than a total available power.

Each of these constraints is imposed on the cost function by the charging control software module 102, and bounds are placed on the acceptable solutions. In yet further instances, the battery system controller 24 can be connected to an input screen visible to a user. The input screen can be a vehicle screen, a connected mobile device, a PC with web accessibility, or any other connected screen. The use of an input screen, or similar device, allows the vehicle operator to input data including an expected departure time, a ranked list of priorities (e.g. charging efficiency being more important than charging speed), and any other constraints on the system. The charging control software module 102 constructs constraints on the optimization cost function (EQN. 1) based on the received inputs. By way of example, if the driver intends to leave the vehicle 10 stationary for an extended period of time, the driver can indicate that cost-energy efficiency is a highest priority, battery life is a second highest priority, and charging time is a lowest priority.

In another example, the charging constraint can include an expected distance to be traveled in the next use of the vehicle 10. This can be in the form of an end point global positioning system location, a manually entered distance, or any similar way of providing the estimated distance. The controller can then generate constraints such as “charge must exceed X by departure”, where X is the minimum charge for a round trip of the estimated distance.

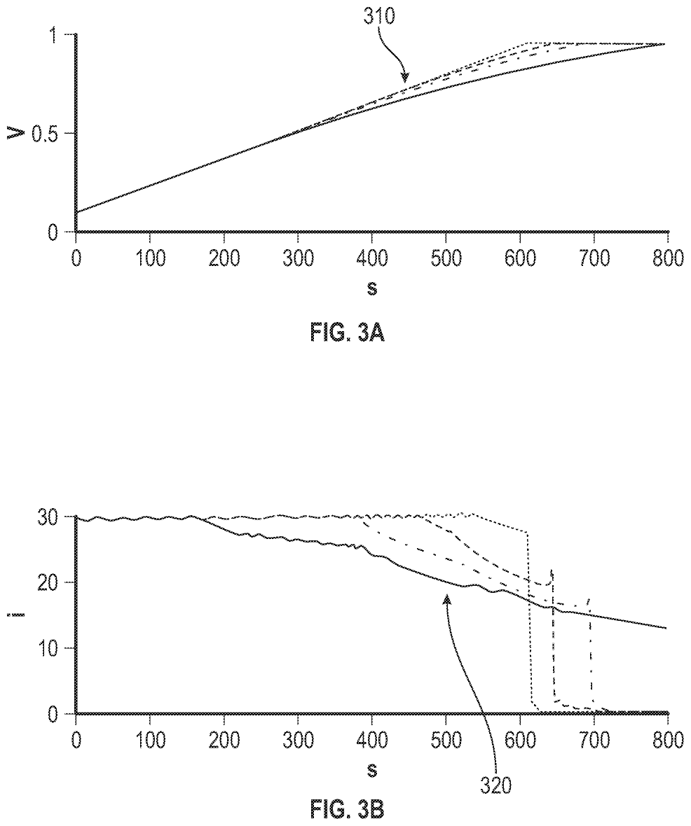

In some examples, the user can input optional constraints, or conflicting constraint preferences. Similarly, in some examples there may be conflicting thermal and charging constraints. In such examples, multiple possible solutions to the optimization cost function can exist. When such is the case, the controller 24 uses a charging profile selection module 104 to generate multiple charging profiles and output the charging profiles to the screen. The charging profile selection module 104 can be a sub-module within the charging control software module 102 as shown or can be a separate interconnected software module. One example of the multiple charging profiles is illustrated in FIGS. 3A and 3B, with FIG. 3A illustrating a set of state of charge charging profiles 310 and FIG. 3B illustrating a set of charging current profiles 320. Each charging profile 310, 320 corresponds to a given balancing of the priorities resulting in variations on the constraints to the optimization cost function defined by EQN. 1. Further, each charging profile 310, 320 includes a distinct balancing of priorities.

When presented with the various charging profiles 310, 320, the user can select the charging profile that is closest to the user's preferred operation. In some examples, the charging control software module 102 can further provide the user with a text description summarizing the conflicting optimization, allowing a less sophisticated user to make an informed decision. The text description can be, in some examples, a ranked list of parameters from order of most importance to least importance, as defined by the user. In one example, the parameters that are ranked include at least charging time, cost-energy efficiency, charging energy monetary cost, and a battery life.

In yet another example, the charging control software module 102 can display a recommended charging profile 310, 320 based on a predetermined optimum, such as maximizing battery life. In such an example, the user may select the recommended charging profile 310, 320, or may decide to select a different charging profile based on personal preferences.

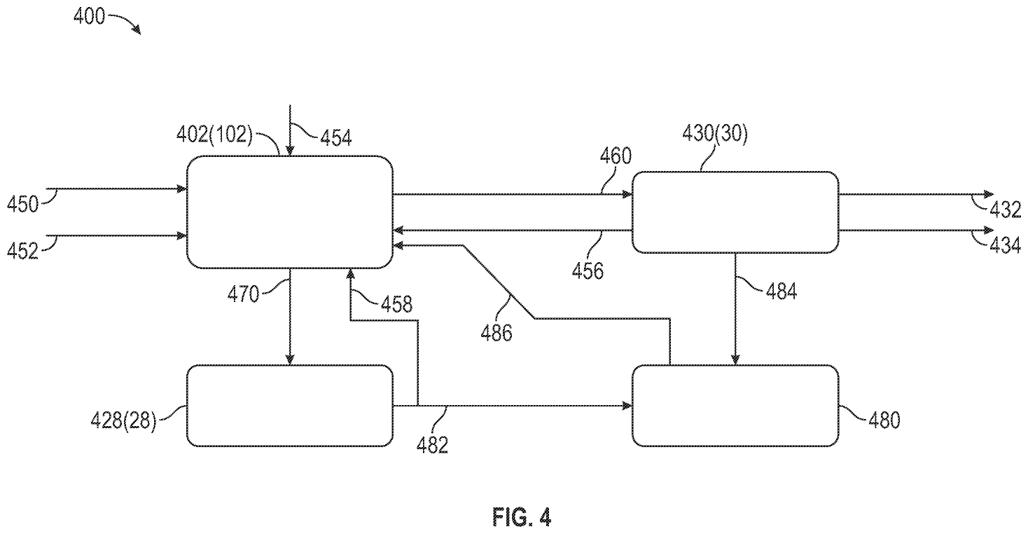

With continued reference to FIGS. 1-3B, FIG. 4 schematically illustrates a representation of a battery charging system 400 for the vehicle of FIG. 1. The battery charging system performs at least two functions. A first function is determining the optimal charging profile as described herein. The determination of the optimal charging profile, including any user selections is performed in advance and does not occur simultaneously with the charging operation itself.

The thermal system 428 (28) predicts the battery temperature and provides the measured battery temperature rate as battery temperature output 482 to a battery aging rate determination module 480. Simultaneously the charging port 430 (30) measures the magnitude of the charging current and provides a measured charging current to the battery aging module 480 via a charging current output 484. The battery aging module 480 uses the received charging current 484 and the received battery temperature 482 to determine a battery aging rate according to known methodologies and provides the battery aging rate to the charging software module 402 (102) via an output 486. In some examples, the battery aging rate determination module 480 is a separate module within the controller systems of the vehicle 10. In alternative examples, the battery aging rate determination module 480 is a software sub-module 480 within the charging control software module 402 (102).

The charging control software module 402 also receives system state variable inputs of an available wall power 450, an ambient temperature around the vehicle 452, and estimated departure time of the driver 454, a current state of charge of the battery 456, and a current temperature of the battery 458. These state variables are applied to the cost function described herein, and a charging profile is determined.

The second function implements the determined charging profile 310, 320 using the charging control software module 402 (102). The implementation can occur immediately subsequent to the determination or at a future time, depending on the determined charging profile. During implementation, the charging control software module 402 (102) outputs a charging power control signal 460 to the charging port 430 (30), and the charging port provides a charging energy efficiency command 432 and a charging time efficiency command 434 to a connected wall charger. The wall charger interprets the received commands 432, 434 and provides charging power to the vehicle 10 through the charging port 30.

Simultaneously, the charging control software module 402 (102) provides a thermal systems control signal 470 to the thermal systems 428 (28). The thermal systems control signal 470 provides operational instructions for the heating or cooling profile to the thermal systems and causes the thermal systems 428 (28) to implement the thermal profile. Throughout the charging process, as the variables provided by the thermal systems 428, the charging port 430, and the battery 480 are provided to the charging control software module 402, the charging control software module 402 uses control techniques to enforce the determined charging profile

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
at least one electric motor configured to convert electric power to rotational motion;
a battery system electrically connected to the at least one electric motor;
a controller coupled to the battery system, the controller including a non-transitory computer readable memory and a processor, the memory storing a charging control software module, the charging control software module being configured to cause the processor to perform the method of determining an optimum charging profile based at least partially on an available received charging power, an ambient temperature of the battery system, charging system constraints, and at least one driver preference.

2. The vehicle of claim 1, wherein the at least one driver preference includes a relative ranking of a set of parameters including at least charging time, cost-energy efficiency, monetary cost, and a battery life.

3. The vehicle of claim 1, wherein the charging system constraints include at least one of an expected distance to next available charge and an expected time until departure.

4. The vehicle of claim 1, wherein determining the optimum charging profile comprises minimizing the cost equation: Eₜ₌₀^{N}g(X, u, W), where
$$g ( X , u , W ) = α * ( 1 - {η}_{e f f} ) + β * Δ t * ( S O {C}_{t} \leq S O {C}_{target} ) + γ * {i}_{a g i n g}$$
and where, η_{eff} is a system efficiency, Δt is the time step used by the optimization algorithm, SOC_{target} is the final charging target of state of charge, i_{aging} is an aging rate of a battery, X is a set of state variables include a battery temperature T and a state of charge SOC, may have other possible other state variable, e.g. lithium ion surface density, u is a ratio of battery charge to battery thermal (heat or cool) power, and W is an available power from outsource to the vehicle, maybe through the charger or through wireless.

5. The vehicle of claim 4, wherein the cost equation further includes at least one of a charging time is less than driver needs, state of charge end equals state of charge target, power required by the battery is less than charge limits, power required by thermal systems (heater or cooling) is less than a thermal system power limit, and power required by the battery plus power required by the thermal system is less than a total available power.

6. The vehicle of claim 4, wherein the memory further stores a charging profile selection module configured to cause the controller to output a plurality of charging profiles to a user selection system and is configured to cause the controller to implement a selected one of the plurality of charging profiles.

7. The vehicle of claim 6, wherein the at least one driver preference includes a relative ranking of a set of parameters including at least charging time, cost-energy efficiency, charging monetary cost, and a battery life, and wherein the plurality of charging profiles corresponds to a unique driver preference ranking.

8. A method for controlling a vehicle charging operation, the method comprising:
determining, using a controller evaluating an optimization cost function, an optimum charging profile based at least partially on an available received charging power, an ambient temperature of a battery system, charging system constraints, and at least one driver preference, wherein the optimization cost function balances a power requirement of a battery thermal system and a battery charging system.

9. The method of claim 8, wherein evaluating an optimization cost function comprises minimizing the cost equation: Σₜ₌₀^{N}g(X, u, W), where g(X,u,W)=α*(1−η_{eff})+β *Δt*(SOCₜ≤SOC_{target})+γ *i_{aging}; and
where η_{eff} is a system efficiency, Δt is the time step used by the optimization algorithm, SOC_{target} is the final charging target of state of charge, i_{aging} is an aging rate of a battery, X is a set of state variables include a battery temperature T and a state of charge SOC, u is a ratio of battery charge to battery thermal power, and W is an available power from outsource to the vehicle maybe through the charger or through wireless.

10. The method of claim 9, wherein the cost equation further includes at least one of a charging time is less than driver needs, state of charge end equals state of charge target, power required by the battery is less than a charge power limit, power required by a thermal system (heater or cooler) is less than a thermal system power limit, and power required by the battery plus power required by thermal system is less than a total available power.

11. The method of claim 9, wherein the memory further stores a charging profile selection module configured to cause the controller to output a plurality of charging profiles to a user selection system and is configured to cause the controller to implement a selected one of the plurality of charging profiles.

12. The method of claim 11, wherein the at least one driver preference includes a relative ranking of a set of parameters including at least charging time, cost-energy efficiency, and a battery life, and wherein the plurality of charging profiles corresponds to a unique driver preference ranking.

13. The method of claim 8, wherein the at least one driver preference includes a relative ranking of a set of parameters including at least charging time, cost-energy efficiency, and a battery life.

14. The method of claim 8, wherein the charging system constraints include at least one of an expected distance to next available charge and an expected time until departure.

15. A charging control module for a vehicle comprising:
a plurality of inputs configured to receive at least a temperature sensor output and an available wall power value;
a plurality of outputs configured to output at least a thermal power control signal and a charging power control signal;
a processor and a memory storing instructions configured to cause the processor to evaluate an optimization cost function and thereby determine an optimum charging profile based at least partially on an available received charging power, an ambient temperature of a battery system, charging system constraints, and at least one driver preference, wherein the optimization cost function balances a power requirement of a battery thermal system and a battery charging system; and
wherein evaluating an optimization cost function comprises minimizing the cost equation: Σₜ₌₀^{N}g(X, u, W), where g(X, u, W)=α*(1−η_{eff})+β *Δt*(SOCₜ≤ SOC_{target})+γ *i_{aging};
and where, η_{eff} is a system efficiency, Δt is the time step used by the optimization algorithm, SOC_{target} is the final charging target of state of charge, i_{aging} is an aging rate of a battery, X is a set of state variables include a battery temperature T and a state of charge SOC, may have other possible other state variable, e.g. lithium ion surface density, u is a ratio of battery charge to battery thermal power, and W is an available power from outsource to the vehicle maybe through the charger or through wireless.

16. The charging control module of claim 15, further including a battery aging sub-module, the battery aging sub module being configured to determine at least the aging rate of the battery based on a charging rate of the battery and a temperature of the battery.

17. The charging control module of claim 15, further comprising at least one user selection system configured to display a plurality of charging profiles, receive a user selection of a single charging profile from the plurality of charging profiles, and implement the charging profile.

18. The charging control module of claim 15, further comprising a user selection figure configured to allow a user to input one or more constraints, and wherein evaluating an optimization cost function includes constraining the optimization cost function with the one or more constraints.

19. The charging control module of claim 18, wherein the one or more constraints includes at least one constraint selected from the list of: a charging time is less than driver needs, state of charge end equals state of charge target, power required by the battery is less than charge limits, power required by a thermal system is less than a thermal system power limit, and power required by the battery plus power required by the thermal system is less than a total available power.

20. The charging control module of claim 18, wherein the one or more constraints includes an ordered ranking of priorities.
